(19) United States
(12) Patent Application Publication
(10) Pub. No.: US 2020/0051453 A1
(43) Pub. Date: Feb. 13, 2020

(54) SCORING METHOD AND SYSTEM FOR DIVERGENT THINKING TEST

(71) Applicant: National Taiwan Normal University, Taipei City (TW)

(72) Inventors: Yao-Ting SUNG, Taipei City (TW); Kuo-En CHANG, Taipei City (TW); Hou-Chiang TSENG, Taipei City (TW); Hao-Hsin CHENG, Taipei City (TW)

(73) Assignee: National Taiwan Normal University, Taipei City (TW)

(21) Appl. No.: 16/249,349

(22) Filed: Jan. 16, 2019

(30) Foreign Application Priority Data
Aug. 13, 2018 (TW) 107128121

(51) Int. Cl. G09B 19/00; G06F 17/27

(52) U.S. Cl. CPC G09B 19/00; G06F 17/2785

(57) ABSTRACT

A scoring method includes steps of: storing a word list in a database of a computer; storing word vector combinations in the database; extracting a keyword from a submitted answer, and looking up, in the word list, a word vector that corresponds to a word which conforms with the keyword; and obtaining, from the database, one of the word vector combinations, and calculating, for each of benchmark nouns of the one of the word vector combinations thus obtained, a semantic distance between the keyword and the benchmark noun based on word vectors respectively corresponding to the keyword and the benchmark noun, and calculating an originality score based on the semantic distances of the respective benchmark nouns thus calculated.

### CROSS-REFERENCE TO RELATED APPLICATION

This application claims priority of Taiwanese Invention Patent Application No. 107128121, filed on Aug. 13, 2018.

### FIELD

The disclosure relates to a scoring method and a scoring system, and more particularly to as coring method and a scoring system for a divergent thinking test.

### BACKGROUND

A divergent thinking test is utilized to assess creativity of an individual in aspects of fluency, originality and flexibility based respectively on the number of ideas considered, whether there is a unique or unusual idea, and the number of categories the considered ideas fall into while answering an open question. A conventional scoring method for a divergent thinking test is conducted by man based on norm-referenced evaluation. However, the conventional scoring method has drawbacks of involving complicated procedures for scoring, and higher cost of development and maintenance of a norm. In addition, subjective judgment by man plays an important role in the conventional scoring method due to inability to predict all possible responses to a provided open question.

### SUMMARY

Therefore, an object of the disclosure is to provide a scoring method and a scoring system for a divergent thinking test that can alleviate at least one of the drawbacks of the prior art.

According to one aspect of the disclosure, the scoring method for a divergent thinking test is to be implemented by a computer which obtains a submitted answer that corresponds to a selected one of a plurality of test questions of the divergent thinking test. The method includes steps of:
(A) storing a word list in a database of the computer, the word list including a plurality of words which are obtained from Chinese linguistic corpus data of different sources, and a plurality of word vectors which correspond respectively to the plurality of words;
(B) storing a plurality of word vector combinations in the database of the computer, each of the plurality of word vector combinations corresponding to a respective one of the test questions and including a plurality of benchmark nouns which represent non-creativeness and each of which corresponds to one of the word vectors that corresponds to one of the plurality of words in the word list conforming with the benchmark noun;
(C) by an answer processing module of the computer, extracting at least one keyword from the submitted answer, and looking up, in the word list, one of the word vectors that corresponds to one of the plurality of the words which conforms with the at least one keyword; and
(D) by an originality scoring module of the computer, obtaining, from the database of the computer, one of the plurality of word vector combinations that corresponds to the selected one of the test questions, and calculating, for each of the plurality of benchmark nouns of the one of the plurality of word vector combinations thus obtained, a semantic distance between the at least one keyword in the submitted answer and the benchmark noun based on said one of the word vectors that corresponds to the at least one keyword and said one of the word vectors that corresponds to the benchmark noun, and calculating an originality score based on the semantic distances of the respective benchmark nouns thus calculated.

According to another aspect of the disclosure, the scoring system for a divergent thinking test is configured to obtain a submitted answer that corresponds to a selected one of a plurality of test questions of the divergent thinking test. The scoring system includes a database, an answer processing module and an originality scoring module.

The database is configured to store a word list that includes a plurality of words which are obtained from Chinese linguistic corpus data of different sources, and a plurality of word vectors which correspond respectively to the plurality of the words, and to store a plurality of word vector combinations. Each of the plurality of word vector combinations corresponds to a respective one of the test questions, and includes a plurality of benchmark nouns which represent non-creativeness. Each of the plurality of benchmark nouns corresponds to one of the plurality of word vectors that corresponds to one of the plurality of words in the word list conforming with the benchmark noun.

The answer processing module is configured to extract at least one keyword from the submitted answer, and to look up, in the word list, one of the word vectors that corresponds to one of the plurality of words which conforms with the at least one keyword.

The originality scoring module is configured to obtain, from the database, one of the plurality of word vector combinations that corresponds to the selected one of the test questions, to calculate, for each of the plurality of benchmark nouns of the one of the plurality of word vector combinations thus obtained, a semantic distance between the at least one keyword in the submitted answer and the benchmark noun based on said one of the word vectors that corresponds to the at least one keyword and said one of the word vectors that corresponds to the benchmark noun, and to calculate an originality score based on the semantic distances of the respective benchmark nouns thus calculated.

### BRIEF DESCRIPTION OF THE DRAWINGS

Other features and advantages of the disclosure will become apparent in the following detailed description of the embodiment with reference to the accompanying drawings, of which:

FIG. 1 is a flow chart illustrating an embodiment of a scoring method for a divergent thinking test according to the disclosure;

FIG. 2 is a block diagram illustrating an embodiment of a scoring system for a divergent thinking test according to the disclosure;

FIG. 3 is a schematic diagram illustrating an embodiment of a word list of the scoring system according to the disclosure;

FIG. 4 is a schematic diagram illustrating an embodiment of calculating an originality score by the scoring method according to the disclosure; and

FIG. 5 is a schematic diagram illustrating an embodiment of calculating a flexibility score by the scoring method according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

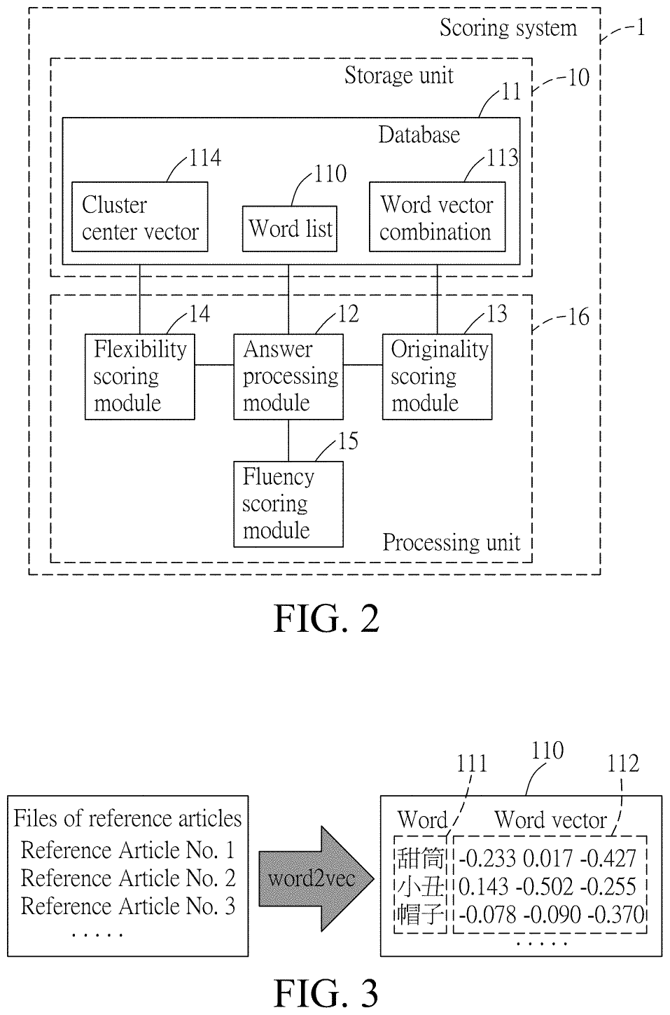

Referring to FIG. 2, an embodiment of a scoring system 1 for a divergent thinking test is illustrated. The scoring system 1 is configured to obtain at least one submitted answer that corresponds to a selected one of multiple test questions of the divergent thinking test, and to assess performance of a subject under the divergent thinking test based on the submitted answer thus obtained. In this embodiment, the scoring system 1 is implemented to be a personal computer, a data server, or any circuit configurable/programmable in a software manner and/or hardware manner to implement functionalities described in this disclosure. However, implementation of the scoring system 1 is not limited to the disclosure herein.

As shown in FIG. 2, the scoring system 1 includes a storage unit 10 and a processing unit 16. The storage unit 10 includes a database 11. The processing unit 16 includes an answer processing module 12, an originality scoring module 13, a flexibility scoring module 14 and a fluency scoring module 15.

The database 11 is configured to store a word list 110 that includes a plurality of words 111 (see FIG. 3) which are obtained from Chinese linguistic corpus data of different sources, and a plurality of word vectors 112 (see FIG. 3) which correspond respectively to the plurality of words 111. Herein, a word may be a term or a vocabulary, which may contain one or more characters and convey meaning on its own. In modern Chinese, the majority of Chinese words each consist of two or more characters. Specifically speaking, the Chinese linguistic corpus data includes a plurality of reference articles. The plurality of words 111 in the word list 110 are obtained by performing a word segmentation algorithm on the plurality of reference articles. The plurality of word vectors 112 are obtained by performing word embedding respectively on the plurality of words 111 based on Word2vec. In addition, the database 11 is configured to store a plurality of word vector combinations 113. Each of the plurality of word vector combinations 113 corresponds to a respective one of the test questions, and includes a plurality of benchmark nouns which represent non-creativeness. Each of the plurality of benchmark nouns corresponds to one of the plurality of word vectors 112 that corresponds to one of the plurality of words 111 in the word list 110 conforming with the benchmark noun. Since word segmentation algorithms are well known to one skilled in the relevant art, detailed explanation of the same is omitted herein for the sake of brevity.

The database 11 is further configured to store a plurality of cluster center vectors 114 respectively of a plurality of semantic clusters. Each of the plurality of semantic clusters includes a plurality of article vectors that respectively represent the reference articles in a portion of the reference articles that corresponds to the semantic cluster. For each of the semantic clusters, each of the article vectors is a vector sum of the word vectors 112 of keywords in the respective one of the reference articles, where the word vectors 112 are obtained by looking up in the word list 110 based on the keywords. In this embodiment, the semantic clusters are formed by performing a clustering algorithm, according to semantics of the reference articles, on the article vectors that respectively correspond to the reference articles. For each of the semantic clusters, the cluster center vector 114 is calculated based on the article vectors included in the semantic cluster so as to represent the semantic cluster; for example, the article vectors are averaged to obtain the cluster center vector 114. The clustering algorithm may be implemented to be K-means clustering, density peak clustering, or hierarchical clustering, but implementation of the clustering algorithm is not limited to the disclosure herein and may vary in other embodiments. Since the clustering algorithms are well known to one skilled in the relevant art, detailed explanation of the same is omitted herein for the sake of brevity.

The answer processing module 12 is configured to extract at least one keyword from the submitted answer, and to look up, in the word list 110, one of the word vectors 112 that corresponds to one of the plurality of words 111 which conforms with the at least one keyword. Specifically speaking, the answer processing module 12 is configured to perform the word segmentation algorithm on the submitted answer so as to result in a segmented submitted answer, and to remove all swear words from the segmented submitted answer based on a pre-established list of swearwords and based on a ratio of single-character words in the segmented submitted answer and a total number of words in the segmented submitted answer. The pre-established list of swear words contains swear words that are frequently used, and swearwords, if any, in the segmented submitted answer can be found and removed by comparison. The answer processing module 12 is configured to, based on inverse document frequency (IDF), extract the at least one keyword from the segmented submitted answer that has had all swear words therein removed. Since the IDF technique has been well known to one skilled in the relevant art, detailed explanation of the same is omitted herein for the sake of brevity.

The originality scoring module 13 is configured to obtain, from the database 11, one of the plurality of word vector combinations 113 that corresponds to the selected one of the test questions. The originality scoring module 13 is configured to calculate, for each of the plurality of benchmark nouns of the one of the plurality of word vector combinations 113 thus obtained, a semantic distance between the at least one keyword in the submitted answer and the benchmark noun based on said one of the word vectors 112 that corresponds to the at least one keyword and on said one of the word vectors 112 that corresponds to the benchmark noun. Specifically speaking, the originality scoring module 13 is configured to, for each of the plurality of benchmark nouns of the one of the plurality of word vector combinations 113 thus obtained, obtain a semantic similarity between the at least one keyword in the submitted answer and the benchmark noun by calculating a cosine similarity based on said one of the word vectors 112 that corresponds to the at least one keyword and on said one of the word vectors 112 that corresponds to the benchmark noun. For one keyword in the submitted answer and one corresponding benchmark noun, the greater the cosine similarity, the greater the semantic similarity. In other words, the smaller the cosine similarity, the smaller the semantic similarity. The originality s coring module 13 is configured to calculate a result of one minus the semantic similarity so as to obtain the semantic distance between the at least one keyword in the submitted answer and the benchmark noun.

In addition, the originality scoring module 13 is configured to calculate an originality score based on the semantic distances thus calculated for the respective plurality of benchmark nouns. Specifically speaking, the originality scoring module 13 is configured to, when the at least one keyword in the submitted answer is one in number, calculate a mean of the semantic distances to obtain the originality score. The originality scoring module 13 is configured to, when the at least one keyword in the submitted answer is plural in number, calculate, for each of the keywords in the submitted answer, a mean of the semantic distances each between the keyword and the respective one of the plurality of benchmark nouns, and calculate a sum of the means of the semantic distances thus calculated for the keywords in the submitted answer, in order to obtain the originality score.

The flexibility scoring module 14 is configured to calculate, for each of the cluster center vectors 114 respectively of the plurality of semantic clusters, a semantic similarity between the at least one keyword in the submitted answer and the semantic cluster corresponding to the cluster center vector 114 based on the cluster center vector 114 and said one of the word vectors 112 that corresponds to the at least one keyword. The flexibility scoring module 14 is configured to calculate a flexibility score based on top-N ones of the semantic clusters that are most similar to the at least one keyword in the submitted answer in terms of the semantic similarity, where N is a positive integer not smaller than three. The flexibility scoring module 14 is configured to, when the at least one keyword in the submitted answer is one in number, count a total number of the top-N ones of the semantic clusters that are most similar to the at least one keyword in the submitted answer in terms of the semantic similarity as the flexibility score (i.e., the total number would be AT). The flexibility scoring module 14 is configured to, when the at least one keyword in the submitted answer is plural in number, count a total number of elements in a union of sets each consisting of the top-N ones of the semantic clusters that are most similar to a respective one of the keywords in the submitted answer in terms of the semantic similarity to obtain the flexibility score.

The fluency scoring module 15 is configured to count a number of the submitted answer(s) that are free of swearwords so as to obtain a fluency score. Specifically, the answer processing module 12 first removes swearwords, if any, from the submitted answer (s), and then the fluency scoring module 15 counts the number of the submitted answer(s) that has had the swear words therein removed to result in the fluency score. In one instance, one submitted answer may originally contain swearwords only, and thus after removal of swear words, this submitted answer becomes non-existent to the fluency scoring module 15 when obtaining the fluency score.

It should be noted that the answer processing module 12, the originality scoring module 13, the flexibility scoring module 14 and the fluency scoring module 15 may be implemented as blocks of codes (software) that can be invoked to implement corresponding functions or algorithms. In practice, an application program including these blocks of codes can be loaded into the processing unit 16 (e.g., a processor of a personal computer) for execution.

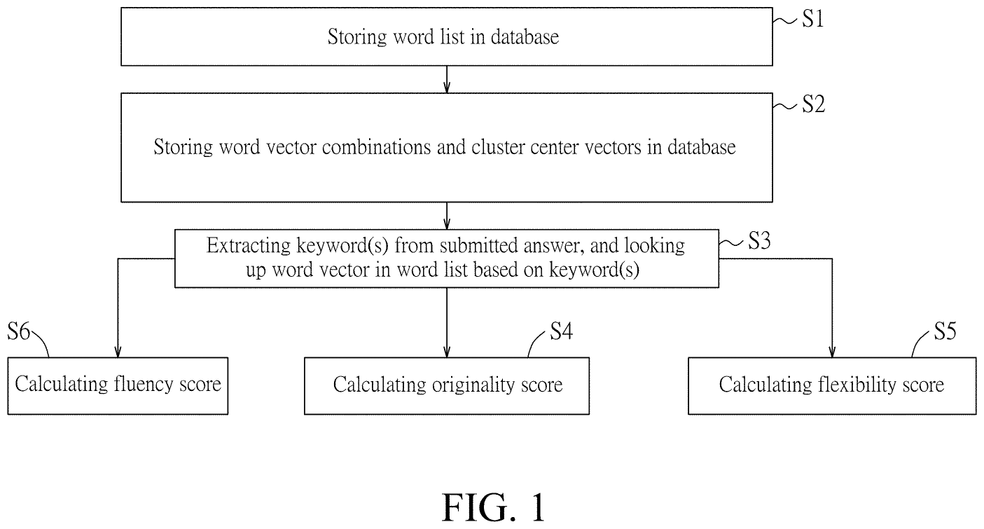

Referring to FIG. 1, an embodiment of a scoring method for a divergent thinking test is illustrated. The scoring method is to be implemented by a computer which serves as the scoring system 1 that is previously described. The method includes steps S1 to S6 described as follows.

In step S1, the computer stores the word list 110 in the database 11 of the computer. Referring to FIG. 3, the word list 110 includes the words 111, such as “ [symbol] (ice cream cone)”, “ [symbol] (clown)”, and “ [symbol] (hat)”. The word list 110 further includes the word vectors 112 which correspond respectively to the words 111. The words 111 are obtained from Chinese linguistic corpus data of different sources, such as around seven-million-eight-hundred-and-twenty-thousand Chinese reference articles collected from Chinese Gigaword, Academia Sinica Balanced Corpus of Modern Chinese, United Daily News, textbooks, extracurricular reading materials, web columns, electronic literature and PTT Bulletin Board System. However, the sources are not limited to what are disclosed herein and may vary in other embodiments. The words 111 in the word list 110 are obtained by performing the word segmentation algorithm on the reference articles. The word vectors 112 are obtained by performing word embedding respectively on the words 111 based on Word2vec. In this embodiment, the words 111 are obtained from the reference articles with the assistance of a Chinese word segmentation function provided by Chinese Readability Index Explorer (CRIE), and are collected together into a text file. The text file forms a corpus of roughly one-trillion-and-three-hundred-million Chinese words. Subsequently, the computer performs word embedding on the corpus based on Word2vec to obtain word vectors 112 respectively corresponding to the words 111 in the corpus, and establishes the word list 110 based on the words 111 and the word vectors 112.

TABLE 1

| Test Question | Word Vector Combination No. 1 | |
|---|---|---|
| No. 1 | [symbol] −0.233 0.017 −0.427 | |
| | [symbol] −0.143 0.502 −0.255 | |
| | [symbol] −0.078 −0.090 −0.370 | |
| Test Question | Word Vector Combination No. 2 | |
| No. 2 | ... | ... ... ... |
| | ... | ... ... ... |
| | ... | ... ... ... |
| Test Question | Word Vector Combination No. 3 | |
| No. 3 | ... | ... ... ... |
| | ... | ... ... ... |
| | ... | ... ... ... |

| | |
|---|---|
| ... | ... |

In step S2, the computer stores in advance the word vector combinations 113 in the database 11 of the computer. Each of the word vector combinations 113 corresponds to a respective one of the test questions and includes the benchmark nouns which represent non-creativeness. Each of the benchmark nouns corresponds to one of the word vectors 112 that corresponds to one of the words 111 in the word list 110 conforming with the benchmark noun and that is able to be looked up in the word list 110 based on the benchmark noun. For example, referring to Table 1 above, Word Vector Combination No. 1 corresponding to Test Question No. 1 includes three words, “ [symbol] (ice cream)”, “ [symbol] (human)”, and “ [symbol] (hat)”, and respective word vectors 112 corresponding to the three words. For instance, the word vector 112 for the word “ [symbol] ” is “−0.233 0.017 −0.427”.

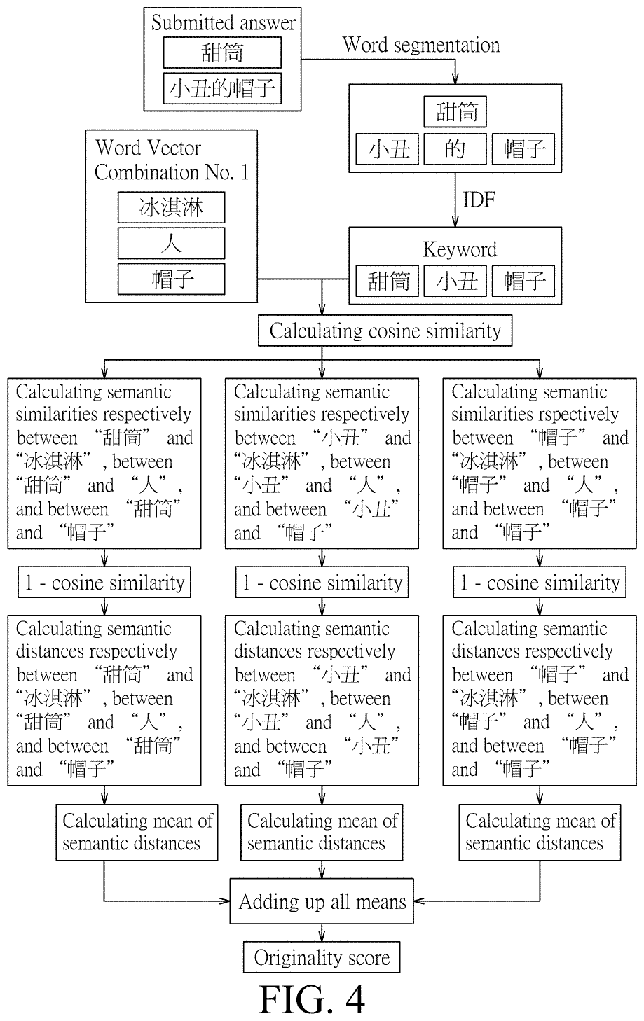

In step S3, when the answer processing module 12 of the computer receives from a testee, at least one submitted answer which may be inputted by speaking, by typing, or by hand-writing, and which corresponds to a test question that is presented in a perceivable way such as in voice or in text, the answer processing module 12 of the computer extracts at least one keyword from the submitted answer, and looks up, in the word list 110, one of the word vectors 112 that corresponds to one of the words 111 which conforms with the at least one keyword. For example, referring to FIG. 4, the submitted answer corresponding to Test Question No. 1 includes “ [symbol] (ice cream cone)” and “ [symbol] (hat of clown)”. At first, the answer processing module 12 performs the word segmentation algorithm provided by CRIE on the submitted answer so as to result in the segmented submitted answer, and based on IDF, removes unimportant words such as “ [symbol] (of)”, “ [symbol] (past tense marker)”, “ [symbol] (have)”, “ [symbol] (up)”, “ [symbol] (piece)”, and “ [symbol] (and)”. Then, the answer processing module 12 removes all swearwords from the segmented submitted answer based on the pre-established list of swear words and on the ratio between the number of single-character words in the segmented submitted answer and the total number of words in the segmented submitted answer, and based on IDF, extracts three keywords, i.e., “ [symbol] (ice cream cone)”, “ [symbol] (clown)”, and “ [symbol] (hat)”, from the segmented submitted answer that has had any swear word therein removed. By looking up in the word list 110 based on the three keywords, respective word vectors 112 corresponding to the three keywords are obtained. Following that, the answer processing module 12 transmits the three keywords to the originality scoring module 13. It is noted that the removal of swear words is an optional procedure and can be omitted according to different needs.

When no keyword is found in the submitted answer, the answer processing module 12 presents a notification message via an output device of the computer, e.g., by displaying the notification message on a display or by playing audio of the notification message via a speaker of the computer, so as to notify the testee to answer the test question again. It should be noted that implementation of presenting the notification message is not limited to the disclosure herein and may vary in other embodiments.

In step S4, the originality scoring module 13 of the computer obtains, from the database 11 of the computer, one of the word vector combinations 113 that corresponds to the selected one of the test questions. As exemplified in Table 1, Word Vector Combination No. 1 corresponding to Test Question No. 1 is obtained, and Word Vector Combination No. 1 includes three benchmark nouns, i.e., “ [symbol] (ice cream)”, “ [symbol] (human)” and “ [symbol] (hat)”, and respective word vectors 112 corresponding to the three benchmark nouns. For each of the benchmark nouns of said one of the word vector combinations 113 thus obtained, the originality scoring module 13 calculates the semantic distance between the at least one keyword in the submitted answer and the benchmark noun based on said one of the word vectors 112 that corresponds to the at least one keyword and on said one of the word vectors 112 that corresponds to the benchmark noun. Subsequently, the originality scoring module 13 calculates an originality score based on the semantic distances of the respective plurality of benchmark nouns thus calculated.

Referring back to FIG. 4 and the aforementioned example where the submitted answer contains the three keywords, i.e., “ [symbol] (ice cream cone)”, “ [symbol] (clown)”, and “ [symbol] (hat)”, for each of the three keywords and for each of the benchmark nouns of the word vector combination 113 thus obtained, i.e., “ [symbol] (ice cream)”, “ [symbol] (human)” and “ [symbol] (hat)”, the originality scoring module 13 obtains the semantic similarity between the keyword in the submitted answer and the benchmark noun by calculating the cosine similarity based on one of the word vectors 112 that corresponds to the keyword and the word vector 112 that corresponds to the benchmark noun.

Then, the originality scoring module 13 calculates, for each of the three keywords and for each of the benchmark nouns of the word vector combination 113 thus obtained, a result of one minus the cosine similarity as shown in FIG. 4 so as to obtain the semantic distance between the keyword, i.e., “ [symbol] (ice cream cone)”, “ [symbol] [symbol] (clown)”, or “ [symbol] (hat)”, in the submitted answer and the benchmark noun, i.e., “ [symbol] (ice cream)”, “ [symbol] (human)” or “ [symbol] (hat)”, which represents non-creativeness. The greater the cosine similarity between the keyword in the submitted answer and the benchmark noun, the shorter the semantic distance between the keyword in the submitted answer and the benchmark noun. That is to way, the smaller the cosine similarity between the keyword in the submitted answer and the benchmark noun, the longer the semantic distance between the keyword in the submitted answer and the benchmark noun.

As what is previously described, since there are three keywords in the submitted answer, for each of the three keywords in the submitted answer, the originality scoring module 13 calculates the mean of the semantic distances each between the keyword and a respective one of the benchmark nouns, and calculates a sum of the means of the semantic distances thus calculated for all three keywords to obtain the originality score. Specifically speaking, for the keyword “ [symbol] (ice cream cone)” in the submitted answer, the originality scoring module 13 calculates the mean of the semantic distances, one between the keyword “ [symbol] (ice cream cone)” and the benchmark noun “ [symbol] (ice cream)”, one between the keyword “ [symbol] (ice cream cone)” and and the benchmark noun “ [symbol] (human)”, and one between the keyword “ [symbol] (ice cream cone)” and the benchmark noun “ [symbol] (hat)”. For the keyword “ [symbol] (clown)” in the submitted answer, the originality scoring module 13 calculates the mean of the semantic distances, one between the keyword “ [symbol] [symbol] (clown)” and the benchmark noun “ [symbol] (ice cream)”, one between the keyword “ [symbol] (clown)” and the benchmark noun “ [symbol] (human)”, and one between the keyword “ [symbol] (clown)” and the benchmark noun “ [symbol] (hat)”. For the keyword “ [symbol] (hat)” in the submitted answer, the originality scoring module 13 calculates the mean of the semantic distances each, one between the keyword “ [symbol] (hat)” and the benchmark noun “ [symbol] (ice cream)”, one between the keyword “ [symbol] (hat)” and the benchmark noun “ [symbol] (human)”, and one between the keyword “ [symbol] (hat)” and the benchmark noun “ [symbol] (hat)”. Subsequently, the originality scoring module 13 sums up the three means thus calculated to obtain the originality score.

In a scenario that only one keyword “ [symbol] (ice cream cone)” is included in the submitted answer, the originality scoring module 13 calculates a mean of the semantic distances each between the keyword “ [symbol] (ice cream cone)” and a respective one of the benchmark nouns, “ [symbol] (ice cream)”, “ [symbol] (human)” and “ [symbol] (hat)” to obtain the originality score.

Additionally, as shown in FIGS. 1 and 2, in step S2, the database 11 further stores the plurality of cluster center vectors 114 that correspond respectively to the semantic clusters. Each of the semantic clusters includes the article vectors that correspond respectively to the corresponding reference articles. That is to say, each of the reference articles corresponds to a respective one of the article vectors, and said each of the article vectors is a result of a vector sum of the word vectors 112 of keywords in the respective one of the reference articles, wherein the word vectors 112 are obtained by looking up in the word list 110 based on the keywords in the respective one of the reference articles. For example, after the word segmentation algorithm is performed on a reference article that includes a sentence “ [symbol] (The weather of today is sunny)”, four keywords, “ [symbol] (today)”, “ [symbol] (of)”, “ [symbol] (weather)” and “ [symbol] (sunny)”, are obtained. Respective word vectors corresponding to the four keywords are looked up in the word list 110, and are added together into a vector sum, which serves as the article vector of the reference article. Through the clustering algorithm like K-means clustering, density peak clustering or hierarchical clustering, the article vectors are clustered into a plurality of semantic clusters. For each of the semantic clusters, the cluster center vector 114 is calculated as an arithmetic mean of the article vectors in the semantic cluster.

In step S5 as shown in FIG. 1, for each of the cluster center vectors 114 respectively of the semantic clusters, the flexibility scoring module 14 of the computer calculates the semantic similarity between the at least one keyword in the submitted answer and the semantic cluster based on the cluster center vector 114 and said one of the word vectors 112 that corresponds to the at least one keyword, and calculates the flexibility score based on top-N ones of the semantic clusters that are most similar to the at least one keyword in the submitted answer in terms of the semantic similarity, where N is a positive integer not smaller than three.

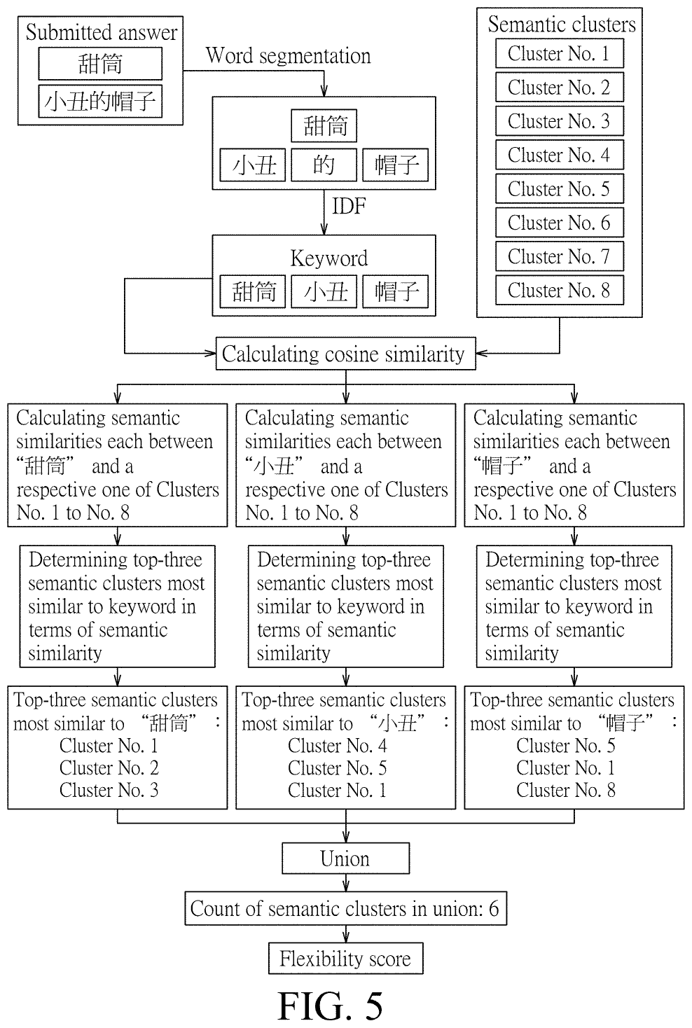

For example, in a scenario that the submitted answer corresponding to Test Question No. 1 includes “ [symbol] (ice cream cone)” and “ [symbol] (hat of clown)” as shown in FIG. 5, as what are previously described in steps S1 to S3, the answer processing module 12 performs the word segmentation on the submitted answer and utilizes IDF to extract three keywords, “ [symbol] (ice cream cone)”, “ [symbol] [symbol] (clown)”, and “ [symbol] (hat)”, from the submitted answer, and looks up in the word list 110 to obtain respective word vectors 112 corresponding to the three keywords. Then, the answer processing module 12 transmits the three keywords and the respective word vectors 112 to the flexibility scoring module 14.

When the semantic clusters are eight in number including Clusters No. 1 to No. 8 as shown in FIG. 5, the flexibility scoring module 14 determines the top-N ones (e.g., N is equal to three) of the semantic clusters that are most similar to the keyword “ [symbol] (ice cream cone)” in terms of the semantic similarity. Specifically speaking, the flexibility scoring module 14 calculates eight cosine similarities each between the word vector 112 of the keyword “ [symbol] (ice cream cone)” and a respective one of the eight cluster center vectors 114 of the eight semantic clusters (i.e., Clusters No. 1 to No. 8) so as to obtain eight semantic similarities. In this example, the flexibility scoring module 14 determines that Clusters No. 1 to No. 3 are most similar to the keyword “ [symbol] (ice cream cone)” in terms of the semantic similarity. Similarly, the flexibility scoring module 14 determines that the top-three the semantic clusters which are most similar to the keyword “ [symbol] (clown)” in terms of the semantic similarity are Clusters No. 4, No. 5 and No. 1, and determines that the top-three semantic clusters which are most similar to the keyword “ [symbol] (hat)” in terms of the semantic similarity are Clusters No. 5, No. 1 and No. 8. Therefore, Clusters Nos. 1, 2, 3, 4, 5 and 8 are the union of the semantic clusters thus determined, and the total number of elements in the union of the semantic clusters is counted by the flexibility scoring module 14 to be six which is used to serve as the flexibility score.

In a scenario that only one keyword “ [symbol] (ice cream cone)” is included in the submitted answer, the flexibility scoring module 14 counts a total number of the top-N ones (e.g., N is equal to three) of the semantic clusters that are most similar to the keyword “ [symbol] (ice cream cone)” in terms of the semantic similarity as the flexibility score. As what has been described, a count number of Clusters No. 1 to No. 3, which are most similar to the keyword “ [symbol] (ice cream cone)” in terms of the semantic similarity, is equal to three and serves as the flexibility score.

Referring back to FIG. 1, in step S6, the fluency scoring module 15 counts a number of the submitted answer(s) containing no swear words therein so as to obtain a fluency score. Specifically, the answer processing module 12 first removes swear words, if any, from the submitted answer, and then the fluency scoring module 15 counts the number of swear-word-free submitted answer(s) to result in the fluency score. For example, in a scenario that the submitted answers corresponding to Test Question No. 1 are “ [symbol] (ice cream cone)” and “ [symbol] (hat of clown)”, since no swear word is contained in the two submitted answers, the submitted answers are still “ [symbol] (ice cream cone)” and “ [symbol] [symbol] (hat of clown)” after the removal of swear words, and the fluency scoring module 15 would obtain a count equal to two, which serves as the fluency score.

In summary, the scoring method according to the disclosure includes steps of storing the word list 110 and the word vector combinations 113 in the database 11. After extracting the keyword from the submitted answer, the step of looking up, in the word list 110, the word vector 112 that corresponds to the word 111 which conforms with the keyword, and the step of obtaining one of the word vector combinations 113 from the database 11 that corresponds to the selected test question are performed. Subsequently, for each of benchmark nouns of the one of the word vector combinations 113 thus obtained, the semantic distance between the keyword and the benchmark noun based on word vectors 112 respectively corresponding to the keyword and the benchmark noun is calculated, and the originality score is also calculated based on the semantic distances of the respective benchmark nouns. Additionally, the scoring method includes the step of calculating, for each of the cluster center vectors 114 respectively of the semantic clusters stored in the database 11, the semantic similarity between the keyword in the submitted answer and the semantic cluster based on the cluster center vector 114 and the word vector 112 that corresponds to the keyword, and the step of calculating the flexibility score based on top-N ones of the semantic clusters that are most similar to the keyword in the submitted answer in terms of the semantic similarity. Besides facilitating assessment of performance of a testee under the divergent thinking test, the scoring method according to the disclosure may reduce subjective influence of human on the assessment, resulting in more objective results of the assessment.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A scoring method for a divergent thinking test, to be implemented by a computer which obtains a submitted answer that corresponds to a selected one of a plurality of test questions of the divergent thinking test, the method comprising:
(A) storing a word list in a database of the computer, the word list including a plurality of words which are obtained from Chinese linguistic corpus data of different sources, and a plurality of word vectors which correspond respectively to the plurality of words;
(B) storing a plurality of word vector combinations (113) in the database of the computer, each of the plurality of word vector combinations corresponding to a respective one of the test questions and including a plurality of benchmark nouns which represent non-creativeness and each of which corresponds to one of the word vectors that corresponds to one of the plurality of words in the word list conforming with the benchmark noun;
(C) by an answer processing module of the computer, extracting at least one keyword from the submitted answer, and looking up, in the word list, one of the word vectors that corresponds to one of the plurality of words which conforms with the at least one keyword; and
(D) by an originality scoring module of the computer, obtaining, from the database of the computer, one of the plurality of word vector combinations that corresponds to the selected one of the test questions, and calculating, for each of the plurality of benchmark nouns of the one of the plurality of word vector combinations thus obtained, a semantic distance between said at least one keyword in the submitted answer and the benchmark noun based on said one of the word vectors that corresponds to the at least one keyword and said one of the word vectors that corresponds to the benchmark noun, and calculating an originality score based on the semantic distances thus calculated respectively for the plurality of benchmark nouns.

2. The scoring method as claimed in claim 1, wherein step (C) includes sub-steps of:
(C11) by the answer processing module, performing a word segmentation algorithm on the submitted answer so as to result in a segmented submitted answer;
(C12) by the answer processing module, removing a swear word from the segmented submitted answer based on a pre-established list of swear words and based on a ratio between a number of single-character words in the segmented submitted answer and a total number of words in the segmented submitted answer; and
(C13) by the answer processing module, based on inverse document frequency (IDF), extracting the at least one keyword from the segmented submitted answer that has had the swear word removed.

3. The method as claimed in claim 1, wherein step (D) includes by the originality scoring module for each of the plurality of benchmark nouns of the one of the plurality of word vector combinations thus obtained:
obtaining a semantic similarity between the at least one keyword in the submitted answer and the benchmark noun by calculating a cosine similarity based on said one of the word vectors that corresponds to the at least one keyword and said one of the word vectors that correspond to the benchmark noun, and
calculating one minus the semantic similarity so as to obtain the semantic distance between the at least one keyword in the submitted answer and the benchmark noun.

4. The method as claimed in claim 3, wherein:
by the originality scoring module when the at least one keyword in the submitted answer is one in number, calculating a mean of the semantic distances to obtain the originality score, and
by the originality scoring module when the at least one keyword in the submitted answer is plural in number, calculating, for each of the keywords in the submitted answer, a mean of the semantic distances each between the keyword and a respective one of the plurality of benchmark nouns, and calculating a sum of the means of the semantic distances thus calculated for the keywords to obtain the originality score.

5. The method as claimed in claim 1, wherein:
in step (A), the Chinese linguistic corpus data include a plurality of reference articles;
in step (B), the database of the computer further stores a plurality of cluster center vectors respectively of a plurality of semantic clusters, each of the plurality of semantic clusters including a plurality of article vectors that respectively represent the reference articles in a portion of the plurality of reference articles that corresponds to the semantic cluster, each of the plurality of article vectors being a vector sum of word vectors of keywords of the respective one of the reference articles, where the word vectors are obtained by looking up in the word list according to the keywords; and
the method further comprises a step of
(E) by a flexibility scoring module of the computer, calculating, for each of the cluster center vectors respectively of the plurality of semantic clusters, a semantic similarity between the at least one keyword in the submitted answer and the semantic cluster based on the cluster center vector and said one of the word vectors that corresponds to the at least one keyword, and calculating a flexibility score based on top-N ones of the semantic clusters that are most similar to the at least one keyword in the submitted answer in terms of the semantic similarity, where N is a positive integer not smaller than three.

6. The method as claimed in claim 5, wherein step (E) includes:
by the flexibility scoring module when the at least one keyword in the submitted answer is one in number, counting a total number of the top-N ones of the semantic clusters that are most similar to the at least one keyword in the submitted answer in terms of the semantic similarity as the flexibility score, and
by the flexibility scoring module when the at least one keyword in the submitted answer is plural in number, counting a total number of elements in a union of sets each consisting of the top-N ones of the semantic clusters that are most similar to a respective one of the keywords in the submitted answer in terms of the semantic similarity to obtain the flexibility score.

7. The method as claimed in claim 5, wherein:
the semantic clusters are formed by performing a clustering algorithm, according to semantics of the reference articles, on the article vectors that respectively correspond to the reference articles; and
for each of the semantic clusters, the cluster center vector (114) is calculated based on the article vectors included in the semantic cluster so as to represent the semantic cluster.

8. The method as claimed in claim 1, wherein:
in step (A), the Chinese linguistic corpus data includes a plurality of reference articles;
the plurality of words in the word list are obtained by performing a word segmentation algorithm on the plurality of reference articles; and
the plurality of word vectors are obtained by performing word embedding respectively on the plurality of words based on Word2 vec.

9. A scoring system for a divergent thinking test, configured to obtain a submitted answer that corresponds to a selected one of a plurality of test questions of the divergent thinking test, said scoring system comprising:
a database configured
to store a word list that includes a plurality of words which are obtained from Chinese linguistic corpus data of different sources, and a plurality of word vectors which correspond respectively to the plurality of words, and
to store a plurality of word vector combinations, each of the plurality of word vector combinations corresponding to a respective one of the test questions, and including a plurality of benchmark nouns which represent non-creativeness and each of which corresponds to one of the plurality of word vectors that corresponds to one of the plurality of words in the word list conforming with the benchmark noun;
an answer processing module configured to extract at least one keyword from the submitted answer, and to look up, in the word list, one of the word vectors that corresponds to one of the plurality of the words which conforms with the at least one keyword; and
an originality scoring module configured
to obtain, from the database, one of the plurality of word vector combinations that corresponds to the selected one of the test questions,
to calculate, for each of the plurality of benchmark nouns of the one of the plurality of word vector combinations thus obtained, a semantic distance between the at least one keyword in the submitted answer and the benchmark noun based on said one of the word vectors that corresponds to the at least one keyword and said one of the word vectors that corresponds to the benchmark noun, and
to calculate an originality score based on the semantic distances thus calculated respectively for the plurality of benchmark nouns.

10. The scoring system as claimed in claim 9, wherein:
said answer processing module is further configured to perform a word segmentation algorithm on the submitted answer so as to result in a segmented submitted answer, to remove a swear word from the segmented submitted answer based on a pre-established list of swearwords and based on a ratio between a number of single-character words in the segmented submitted answer and a total number of words in the segmented submitted answer, and to extract, based on inverse document frequency (IDF), the at least one keyword from the segmented submitted answer that has had the swear word removed.

11. The scoring system as claimed in claim 9, wherein said originality scoring module is configured to, for each of the plurality of benchmark nouns of the one of the plurality of word vector combinations thus obtained:
obtain a semantic similarity between the at least one keyword in the submitted answer and the benchmark noun by calculating a cosine similarity based on said one of the word vectors that corresponds to the at least one keyword and said one of the word vectors that corresponds to the benchmark noun, and
calculate one minus the semantic similarity so as to obtain the semantic distance between the at least one keyword in the submitted answer and the benchmark noun.

12. The scoring system as claimed in claim 11, wherein:
said originality scoring module is configured to
when the at least one keyword in the submitted answer is one in number, calculate a mean of the semantic distances to obtain the originality score, and
when the at least one keyword in the submitted answer is plural in number, calculate, for each of the keywords in the submitted answer, a mean of the semantic distances each between the keyword and a respective one of the plurality of benchmark nouns, and calculate a sum of the means of the semantic di stances thus calculated for the keywords to obtain the originality score.

13. The scoring system as claimed in claim 9, wherein:
the Chinese linguistic corpus data includes a plurality of reference articles;
said database is further configured to store a plurality of cluster center vectors respectively of a plurality of semantic clusters, each of the plurality of semantic clusters including a plurality of article vectors that respectively represent the reference articles in a portion of the plurality of the reference articles that corresponds to the semantic cluster, each of the plurality of the article vectors being a vector sum of word vectors of keywords of the respective one of the reference articles, where the word vectors are obtained by looking up in the word list according to the keywords; and
the scoring system further comprises a flexibility scoring module that is configured to
calculate, for each of the cluster center vectors respectively of the plurality of semantic clusters, a semantic similarity between the at least one keyword in the submitted answer and the semantic cluster based on the cluster center vector and said one of the word vectors that corresponds to the at least one keyword, and
calculate a flexibility score based on top-N ones of the semantic clusters that are most similar to the at least one keyword in the submitted answer in terms of the semantic similarity, where N is a positive integer not smaller than three.

14. The scoring system as claimed in claim 13, wherein:
said flexibility scoring module is configured to,
when the at least one keyword in the submitted answer is one in number, count a total number of the top-N ones of the semantic clusters that are most similar to the at least one keyword in the submitted answer in terms of the semantic similarity as the flexibility score, and
when the at least one keyword in the submitted answer is plural in number, count a total number of elements in a union of sets each consisting of the top-N ones of the semantic clusters that are most similar to a respective one of the keywords in the submitted answer in terms of the semantic similarity to obtain the flexibility score.

15. The scoring system as claimed in claim 13, wherein:
the semantic clusters are formed by performing a clustering algorithm, according to semantics of the reference articles, on the article vectors that respectively correspond to the reference articles; and
for each of the semantic clusters, the cluster center vector is calculated based on the article vectors included in the semantic cluster so as to represent the semantic cluster.

16. The scoring system as claimed in claim 9, wherein:
the Chinese linguistic corpus data includes a plurality of reference articles;
the plurality of words in the word list are obtained by performing a word segmentation algorithm on the plurality of reference articles; and
the plurality of word vectors are obtained by performing word embedding respectively on the plurality of the words based on Word2vec.
